(19) United States
(12) Patent Application Publication
(10) Pub. No.: US 2008/0303643 A1
(43) Pub. Date: Dec. 11, 2008

(54) INDIVIDUAL-IDENTIFYING COMMUNICATION SYSTEM AND PROGRAM EXECUTED IN INDIVIDUAL-IDENTIFYING COMMUNICATION SYSTEM

(75) Inventor: Mitsuyoshi ISHIDA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 12/115,131

(22) Filed: May 5, 2008

(30) Foreign Application Priority Data
Jun. 7, 2007 (JP) 2007-151964

(51) Int. Cl. H05B 39/00

(52) U.S. Cl. 340/332

(57) ABSTRACT

An individual-identifying communication system of the present invention comprises: plural light-emitting devices; an imaging device; a display device capable of displaying an image based on image data obtained by said imaging device; a selection device for selecting a predetermined area within the displayed image; a storage device storing plural identification information data for specifying a mobile terminal to communicate with, each of the identification information data being associated with a unique data indicating a lighting pattern of each light-emitting device; an acquisition device acquiring acquisition lighting pattern data from the image data from the imaging device; a determination device determining the unique data corresponding to the acquisition lighting pattern data, based on the acquisition lighting pattern data acquired from selection area image data and plural unique data; and a communication device communicating with a mobile terminal assigned with identification information data corresponding to the determined unique data.

### CROSS-REFERENCE TO RELATED APPLICATIONS

This application claims benefit of priority based on Japanese Patent Application No. 2007-151964 filed on Jun. 7, 2007. The contents of this application are incorporated herein by reference in their entirety.

### BACKGROUND OF THE INVENTION

1. Field of the Invention

The present invention relates to an individual-identifying communication system, and a program executed in an individual-identifying communication system.

2. Discussion of the Background

Conventionally, there has been a system in which an administrator of a facility (e.g., a recreation hall and a concert hall) watches on a monitor a moving image of the interior of the facility captured by a security camera, so as to grasp the existence of a suspicious person, the current position of facility employees, and the like. In such a system, the administrator visually recognizes a facial image of the person displayed to the monitor. Therefore, in the case where the image lacks sharpness or the image is small, visually identifying the person in the image could be difficult.

As a technology capable of solving such a problem, there has been a facial recognition system capturing the face of a moving person such as a pedestrian and then determining from the captured facial image whether or not the person is one of the previously registered people (e.g., see JP-A 2006-236244) Further, technologies for extracting facial features of a specific person out of a plurality of faces in an image have been disclosed (e.g., see JP-A 2006-318352, JP-A 2005-115847, and JP-A 2005-210293). Adopting the above-described facial recognition systems makes it possible to objectively determine whether or not a person in a moving image is one of the previously registered employees, and which of the registered employees the person is.

Meanwhile, technologies obtaining information by recognizing a lighting pattern of a captured light emitter has been disclosed (e.g., see JP-A 2004-48524, JP-A 2003-256783, JP-A 2004-289324, JP-A 2004-343582, and JP-A 2003-256876). According to those technologies, location information is acquired by detecting lighting of a light emitter, and a variety of information such as identification information on the light emitter can be acquired by recognizing the lighting pattern.

Further, in recent years, a technology has existed which uses an IC tag called an RFID (Radio Frequency IDentification tag). According to this technology, location information can be obtained by reading a signal from the RFID tag carried by a person by using a reader.

The contents of JP-A 2006-236244, JP-A 2006-318352, JP-A 2005-115847, JP-A 2005-210293, JP-A 2004-48524, JP-A 2003-256783, JP-A 2004-289324, JP-A 2004-343582, and JP-A 2003-256876 are incorporated herein by reference in their entirety.

### SUMMARY OF THE INVENTION

However, in the method using a facial recognition system as described above, the recognition rate significantly decreases when the person whose image is captured is not facing the substantial front with respect to the camera.

Further, when the administrator wishes to contact the employee in the moving image, the administrator must check who the employee is, and find the mobile phone number of the employee to call the employee. Thus, there has been a problem that a considerable waste of time generates between the time when the administrator wishes to contact the employee and the time when the administrator actually contacts the employee. Particularly, when an emergency contact is needed in such a case where the administrator has found a suspicious person and a prompt action is required or the like, for example it might happen that the administrator loses sight of the suspicious person and is not able to apply necessary measures due to the wasted time, causing a major security problem. Although an approach of having the administrator to memorize phone numbers of all the employees is possible, memorizing phone numbers of all the employees is difficult if there are a large number of employees. Further, the administrator might memorize wrong phone numbers.

Also, as described above, according to the technologies in JP-A 2004-48524, JP-A 2003-256783, JP-A 2004-289324, JP-A 2004-343582, and JP-A 2003-256876, a variety of information such as the location information and the identification information of the light-emitter can be acquired by recognizing the lighting pattern of the light emitter; however, it has not been disclosed that, by using those technologies, the light emitter (the person having the light emitter) displayed in an image obtained by capturing images using a camera and the like can be specified and that communication can be conducted with the person having the light emitter.

Furthermore, although the method using an RFID tag can grasp the approximate location of the person having the RFID tag, it is not possible to identify the person having the RFID tag, out of the people in the image obtained by capturing images using a monitor camera and the like.

The present invention was made with attention focused on the above-mentioned problems, and has an object to provide an individual-identifying communication system and a program executed in the individual-identifying communication system which are capable of easily identifying a person in a captured moving image and of promptly contacting the person.

In order to attain the above-mentioned object, the present invention provides the following.

(1) An individual-identifying communication system comprising:

a plurality of light-emitting devices which light up in lighting patterns different from one another;

an imaging device;

a display device capable of displaying an image based on an image data obtained by capturing images using the imaging device;

a selection device for selecting a predetermined area within the image displayed to the display device;

a storage device storing a plurality of identification information data different from one another for specifying a mobile terminal to communicate with, each of the identification information data being associated with a unique data indicating a lighting pattern of each of the light-emitting device;

an acquisition device acquiring an acquisition lighting pattern data indicating the lighting pattern of the light-emitting device, from the image data obtained by capturing images using the imaging device;

a determination device determining, based on the acquisition lighting pattern data that has been acquired by the acquisition device from a selection area image data indicating an image of the area selected by using the selection device and on the plurality of unique data previously stored in the storage device, the unique data corresponding to the acquisition lighting pattern data; and

a communication device communicating with a mobile terminal assigned with the identification information data associated with the unique data determined by the determination device.

According to the invention of (1), an image based on image data obtained by the imaging device (e.g., a camera) is displayed to the display device (e.g., a display); and when a predetermined area within the displayed image is selected by the selection device, the acquisition lighting pattern data indicating the lighting pattern of the light-emitting device (e.g., LEDs) is acquired from selection area image data indicating the image of the area. Then, based on the acquired acquisition lighting pattern data and the plurality of unique data stored in the storage device (e.g., a memory), the unique data corresponding to the acquired acquisition lighting pattern data is determined. Namely, the unique data of the light-emitting device is determined by recognizing the lighting pattern of the captured light-emitting device. In the case that a person to have a light-emitting device is predetermined for each light-emitting device, identification of the light-emitting device (determination of the unique data) enables identification of the person having the light-emitting device. Further, since the lighting pattern of the light-emitting device can be stably detected unless the light emitted from the light-emitting device is blocked by people or the like, it is possible to drastically diminish the restriction on identification of a person, such that for example the person having the light-emitting device must face front with respect to the imaging device. Accordingly, the person in the image can be easily identified.

Also, when the unique data corresponding to the acquisition lighting pattern data is determined, communication is started with the mobile terminal with which identification information data associated with the determined unique data is assigned.

Namely, since it is possible to communicate with the mobile terminal corresponding to the light-emitting device in the image, only selecting the area including the light-emitting device owned by the person to contact to in the image enables communication with the mobile terminal owned by the person. Therefore, it is not required to memorize the names of the people having a light-emitting device and the phone numbers of the mobile terminals or search those in each case, thereby saving the facility administrator the trouble. Further, it becomes possible to take prompt actions even when an emergency contact is required.

Further, the present invention provides the following.

(2) The individual-identifying communication system according to the above-mentioned (1),

wherein

each of the light-emitting device comprises a location-specifying light-emitting device that lights up in a lighting pattern common in all of the light-emitting devices, and a signal-transmission light-emitting device that lights up in a lighting pattern different for each of the light-emitting device.

According to the invention of (2), each of the light-emitting device is comprised of the location-specifying light-emitting device that lights up in a lighting pattern common in all of the light-emitting devices, and the signal-transmission light-emitting device that lights up in a lighting pattern different for each of the light-emitting device.

Namely, the location of the light-emitting device is identified by recognizing the lighting pattern of the location-specifying light-emitting device, and the unique data of the light-emitting device is determined by recognizing the lighting pattern of the signal-transmission light-emitting device.

When the location of the light-emitting device is to be identified, the existence of the light-emitting device needs to be detected in the image obtained by capturing images.

In the invention of (2), since the location-specifying light-emitting device is provided which lights up in a lighting pattern (e.g., a pattern alternately repeating the lighting and extinguishing at common intervals) that is common in all of the light-emitting devices, it is possible to determine whether or not a light-emitting device exists, from a moving image of a certain period of time (e.g., a period corresponding to the common interval repeating the lighting and extinguishing). Accordingly, the location of all the light-emitting devices can be detected from a moving image for a certain period of time.

Further, since the location-specifying light-emitting device is used for identification of the location of the light-emitting device, the restriction on setting of a lighting pattern of a signal-transmission light-emitting device (e.g., the restriction of setting the interval of repeating the lighting and extinguishing to be equal to or shorter than a predetermined period, in order to facilitate identification of the location) can be diminished. Therefore, it is possible to add variations to the lighting patterns indicated by unique data.

Further, the present invention provides the following.

(3) The individual-identifying communication system according to the above-mentioned (1),

further comprising:

a control device controlling lighting of each of the light-emitting device; and

a judging device judging whether or not the mobile terminal is in communication,

wherein

the control device lights up a light-emitting device corresponding to the unique data associated with the identification information data of the mobile terminal, in a lighting pattern indicated by the unique data of the light-emitting device, when the judging device has judged that the mobile terminal is not in communication, and

the control device lights up the light-emitting device corresponding to the unique data associated with the identification information data of the mobile terminal, in a lighting pattern different from the lighting pattern indicated by the unique data of the light-emitting device, when the judging device has judged that the mobile terminal is in communication.

According to the invention of (3), in the case that the mobile terminal is in communication, the lighting pattern of the corresponding light-emitting device is differentiated from the lighting pattern for the case that the mobile terminal is not in communication.

Therefore, when communicating with the mobile terminal used by the person having the light-emitting device, visually identifying the differences of the lighting patterns enables confirmation of the person in communication in the image.

Further, it becomes possible to direct the course or the like for the person while seeing in the moving image the current location of the person in communication.

Further, the present invention provides the following.

(4) The individual-identifying communication system according to the above-mentioned (1),

wherein

the light-emitting device is an LED, and the LED is provided on a headset.

According to the invention of (4), identification of the lighting pattern of the LEDs provided on the headset that the previously registered person wears enables identification of the person in the moving image obtained by capturing images.

Furthermore, with the headset worn on the head, the person can freely use his or her hands since a voice to the mobile terminal is input from the microphone provided in the headset and the voice from the mobile terminal is output through the speaker provided in the headset.

Further, the present invention provides the following.

(5) The individual-identifying communication system according to the above-mentioned (1),

wherein

the selection device is a pointing device.

According to the invention of (5), an area within a moving image is selected using the pointing device (e.g., a mouse in a computer system). Accordingly, it is possible to easily specify a selecting area intuitively by moving a symbol (e.g., a cursor) indicating the current position on the screen.

Further, the present invention provides the following.

(6) The individual-identifying communication system according to the above-mentioned (1),

wherein

the selection device is a touch panel installed on the front surface of the display device.

According to the invention of (6), an area within a moving image is selected using the touch panel. Accordingly, it is possible to easily specify a selecting area intuitively by touching a predetermined place on the touch panel corresponding to the selection-desired area within the moving image.

Further, the present invention provides the following.

(7) The individual-identifying communication system, according to the above-mentioned (1),

wherein

the mobile terminal is a mobile phone, and the identification information data is a phone number data indicating the phone number of the mobile phone.

According to the invention of (7), when the unique data corresponding to the acquisition lighting pattern data acquired from the image data in the selected area within the moving image is determined, communication is started with the mobile phone with which the phone number associated with the determined unique data is assigned. Accordingly, it is possible to communicate with the person to contact to in the moving image, through the mobile phone.

Further, the present invention provides the following.

(8) An individual-identifying communication system comprising:

a plurality of light-emitting devices which light up in lighting patterns different from one another;

a camera;

a display device capable of displaying an image based on an image data obtained by capturing images using the camera;

an input device for selecting a predetermined area within the image displayed to the display device;

a memory storing a plurality of identification information data different from one another for specifying a mobile terminal to communicate with, each of the identification information data being associated with a unique data indicating a lighting pattern of each of the light-emitting devices;

a communication device capable of communicating with the mobile terminal; and

a controller,

the controller programmed to execute the processing of

(a) capturing images using the camera,

(b) displaying to the display device an image based on an image data obtained in the processing (a),

(c) selecting a predetermined area within the image displayed to the display device, based on an input from the input device,

(d) acquiring an acquisition lighting pattern data indicating the lighting pattern of the light-emitting device, from the image data obtained by capturing images using the camera,

(e) determining, based on an acquisition lighting pattern data acquired from a selection area image data indicating an image of the area selected in the processing (c) and the plurality of unique data previously stored in the memory, the unique data corresponding to the acquired acquisition lighting pattern data, and

(f) communicating, through the communication device, with a mobile terminal assigned with the identification information data associated with the unique data determined in the processing (e).

According to the invention of (8), an image based on image data obtained by the camera is displayed to the display device (for example, a display); and when a predetermined area within the displayed image is selected by the input device (e.g., a mouse in a computer system), the unique data corresponding to the acquisition lighting pattern data is determined, based on the acquisition lighting pattern data acquired from selection area image data indicating the image of the area and on the plurality of unique data previously stored in the memory.

Namely, the unique data of the light-emitting device is determined by recognizing the lighting pattern of the captured light-emitting device. In the case that a person to have a light-emitting device is predetermined for each light-emitting device, identification of the light-emitting device (determination of the unique data) enables identification of the person having the light-emitting device. Further, since the lighting pattern of the light-emitting device can be stably detected unless the light emitted from the light-emitting device is blocked by people or the like, it is possible to drastically diminish the restriction on identification of a person, such that for example the person having the light-emitting device must face front with respect to the camera. Accordingly, the person in the image can be easily identified.

Also, when the unique data corresponding to the acquisition lighting pattern data is determined, communication is started with the mobile terminal with which identification information data associated with the determined unique data is assigned, through the communication device.

Namely, since it is possible to communicate with the mobile terminal corresponding to the light-emitting device in the image, only selecting the area including the light-emitting device owned by the person to contact to in the image enables communication with the mobile terminal owned by the person. Therefore, it is not required to memorize the names of the people having the light-emitting device and the phone numbers of the mobile terminals or search those in each case, thereby saving the facility administrator the trouble. Further, it becomes possible to take prompt actions even when an emergency contact is required.

Further, the present invention provides the following.

(9) A program executed in an individual-identifying communication system that comprises: a plurality of light-emitting devices which light up in lighting patterns different from one another; a camera; a display device capable of displaying an image based on an image data obtained by capturing images using the camera; an input device for selecting a predetermined area within the image displayed to the display device; a memory storing a plurality of identification information data different from one another for specifying a mobile terminal to communicate with, each of the identification information data being associated with a unique data indicating a lighting pattern of each of the light-emitting devices; and a communication device capable of communicating with the mobile terminal, the program comprising

an image capture step of capturing images using the camera,

a display step of displaying to the display device an image based on an image data obtained using the camera,

a selection step of selecting a predetermined area within the image displayed to the display device, based on an input from the input device,

an acquisition step of acquiring an acquisition lighting pattern data indicating the lighting pattern of the light-emitting device, from the image data obtained by capturing images using the camera,

a determination step of determining, based on the acquisition lighting pattern data acquired from a selection area image data indicating an image of the area selected by the input device and on the plurality of unique data previously stored in the memory, the unique data corresponding to the acquisition lighting pattern data, and

a communication step of communicating, through the communication device, with a mobile terminal assigned with the identification information data associated with the unique data determined in the determination step.

According to the invention of (9), an image based on image data obtained by the camera is displayed to the display device (for example, a display); and when a predetermined area within the displayed image is selected by the input device (e.g., a mouse in a computer system), the unique data corresponding to the acquisition lighting pattern data is determined, based on the acquisition lighting pattern data acquired from selection area image data indicating the image of the area and on the plurality of unique data previously stored in the memory.

Namely, the unique data of the light-emitting device is determined by recognizing the lighting pattern of the captured light-emitting device. In the case that a person to have a light-emitting device is predetermined for each light-emitting device, identification of the light-emitting device (determination of the unique data) enables identification of the person having the light-emitting device. Further, since the lighting pattern of the light-emitting device can be stably detected unless the light emitted from the light-emitting device is blocked by people or the like, it is possible to drastically diminish the restriction on identification of a person, such that for example the person having the light-emitting device must face front with respect to the camera. Accordingly, the person in the image can be easily identified.

Also, when the unique data corresponding to the acquisition lighting pattern data is determined, communication is started with the mobile terminal with which identification information data associated with the determined unique data is assigned, through the communication device.

Namely, since it is possible to communicate with the mobile terminal corresponding to the light-emitting device in the image, only selecting the area including the light-emitting device owned by the person to contact to in the image enables communication with the mobile terminal owned by the person. Therefore, it is not required to memorize the names of the people having the light-emitting device and the phone numbers of the mobile terminals or search those in each case, thereby saving the facility administrator the trouble. Further, it becomes possible to take prompt actions even when an emergency contact is required.

According to the present invention, it is possible to easily identify a person in a moving image obtained by capturing images and to promptly contact the person.

### BRIEF DESCRIPTION OF THE DRAWINGS

FIG. 1 is a diagrammatic view showing an entire configuration of an individual-identifying communication system according to one embodiment of the present invention.

FIG. 2 is a perspective view schematically showing the headset shown in FIG. 1.

FIG. 3 is a block diagram showing an internal configuration of the headset.

FIG. 4 is a block diagram showing an internal configuration of the computer shown in FIG. 1.

FIG. 5 is a block diagram showing an internal configuration of the telephone shown in FIG. 1.

FIG. 6 is a block diagram showing an internal configuration of the camera shown in FIG. 1.

FIG. 7 is a block diagram showing an internal configuration of the mobile phone shown in FIG. 1.

FIG. 8 is a view showing one example of a unique data table.

FIG. 9 is a view showing one example of an image displayed to the display provided in the computer.

FIG. 10 is a view showing one example of an image displayed to the display provided in the computer.

FIG. 11 is a view showing one example of an image displayed to the display provided in the computer.

FIG. 12 is a flowchart showing a subroutine of processing of executing individual-identifying communication in the computer.

FIG. 13 is a flowchart showing a subroutine of lighting pattern change processing conducted in a control portion of the headset.

### DESCRIPTION OF THE EMBODIMENTS

The individual-identifying communication system of the present invention will be described with reference to the drawings.

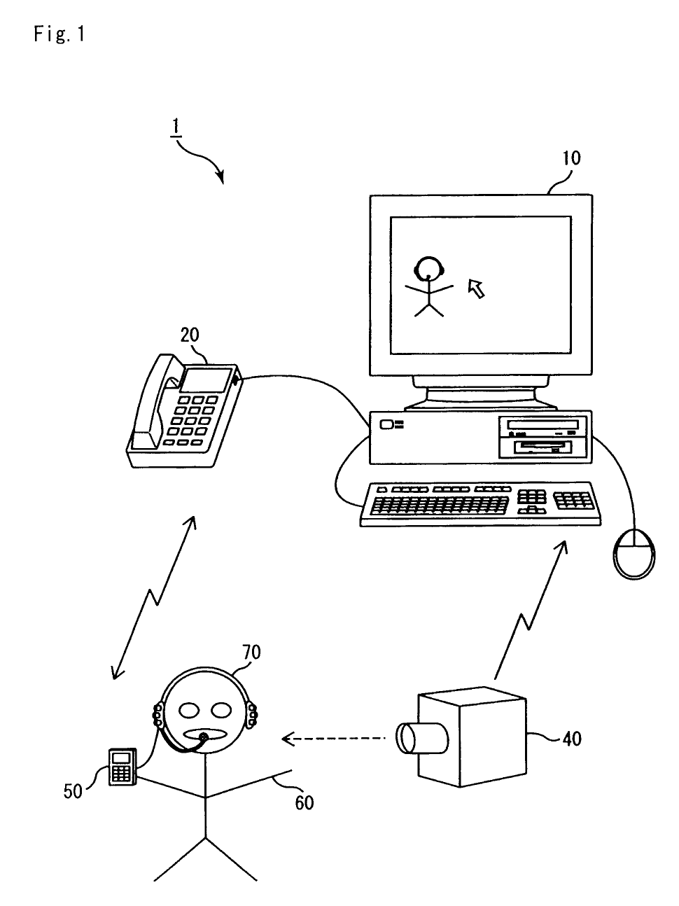

FIG. 1 is a diagrammatic view showing an entire configuration of an individual-identifying communication system according to one embodiment of the present invention.

As shown in FIG. 1, an individual-identifying communication system 1 is provided with a computer 10, a telephone 20 connected to the computer 10 so as to be capable of transmitting data thereto and receiving data therefrom, a camera 40 installed in a facility, a mobile phone 50 owned by a person 60, and a headset 70 connected to the mobile phone 50 so as to be capable of transmitting data thereto and receiving data therefrom.

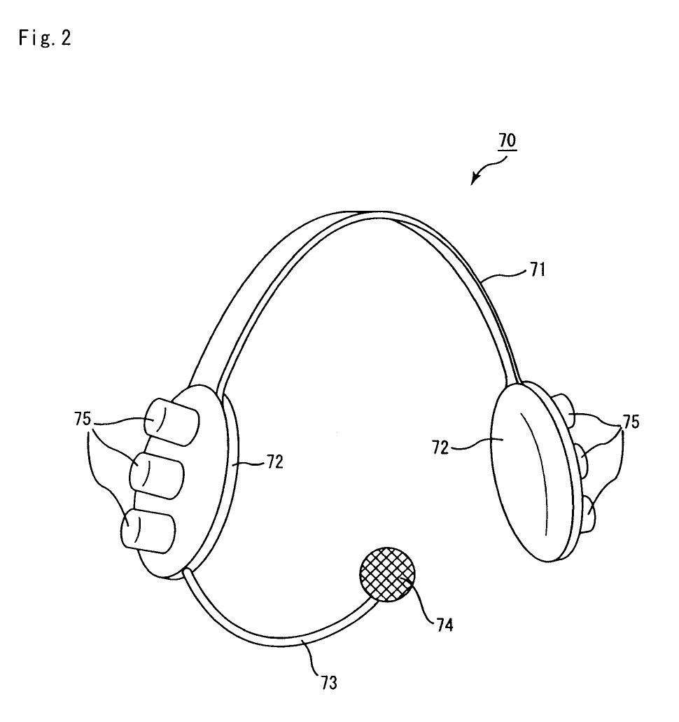

The headset 70 is provided with LEDs 75 (see FIG. 2), and the LEDs 75 light up in a unique lighting pattern previously determined for each headset 70.

The headset 70 is connected to the mobile phone 50, and the person 60 can converse on the mobile phone 50 using the headset 70.

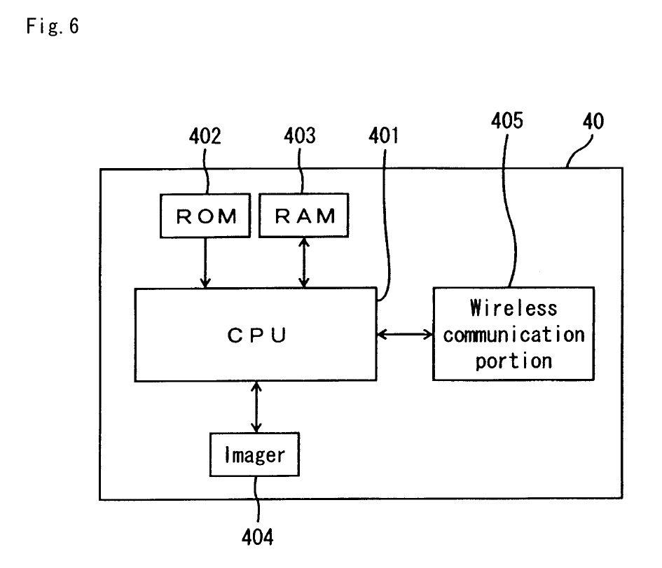

The camera 40 is installed at a predetermined location inside the facility and captures images of a person and the like in the facility. The camera 40 is provided with a zoom function and is vertically and horizontally movable within 100 degrees in each direction. The camera 40 corresponds to the imaging device in the present invention. Image data obtained by capturing images using the camera 40 is transmitted to the computer 10 through a wireless communication portion 405 (see FIG. 6) provided in the camera 40.

It is to be noted that an image captured by the camera 40 is a moving image in the present embodiment.

Further, in the present invention, a facility to have the imaging device installed therein is not particularly limited; examples of the facility include a recreation facility such as a pachinko parlor, a concert hall, a department store and an office building.

Furthermore, although in the present embodiment a case is described where the camera 40 is installed in a facility, the location for installing the imaging device is not limited in the present invention. For example, a configuration may be adopted in which the imaging device is installed outdoors in an urban area or the like so that a specific area is monitored.

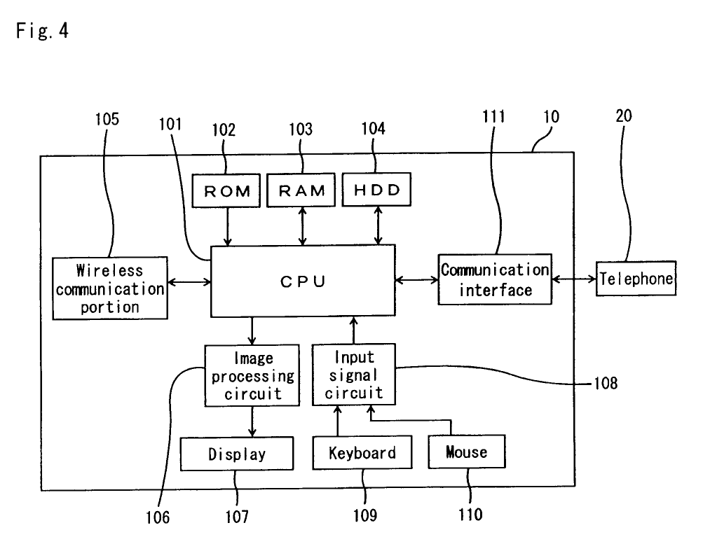

The computer 10 displays to a display 107 (see FIG. 4) an image based on image data received from the camera 40. When an area within the captured moving image is selected by an input from a mouse 110 (see FIG. 4), the computer 10 transmits to the camera 40 a signal commanding to zoom in. The camera 40 captures the enlarged image of the place in the facility corresponding to the selected area. The computer 10 detects an image of the lighting LEDs 75 from the image obtained by zooming in, conducts identification on the lighting pattern of the LEDs 75, and identifies the person wearing the headset 70 provided with the LEDs 75. Then, the computer 10 transmits to the telephone 20 a command signal indicating a command to dial the phone number of the mobile phone 50 owned by this person wearing the headset 70.

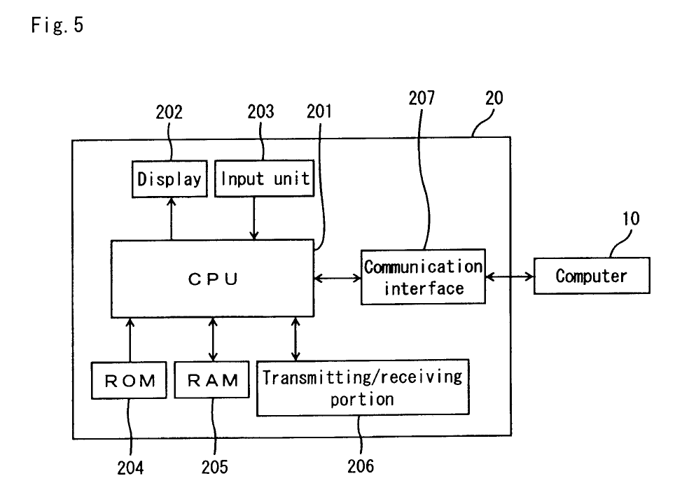

Upon receipt of the command signal from the computer 10, the telephone 20 dials the phone number of the mobile phone 50 of the person to start communication. The telephone 20 corresponds to the communication device in the present invention. The administrator of the facility visually monitoring the images displayed to the display 107 of the computer 10 can converse with the person via a transmitting/receiving portion 206 (see FIG. 5) of the telephone 20.

FIG. 2 is a perspective view schematically showing the headset shown in FIG. 1.

As shown in FIG. 2, the headset 70 is basically comprised of a headband 71, ear pads 72, an arm 73, a microphone 74, and the LEDs 75.

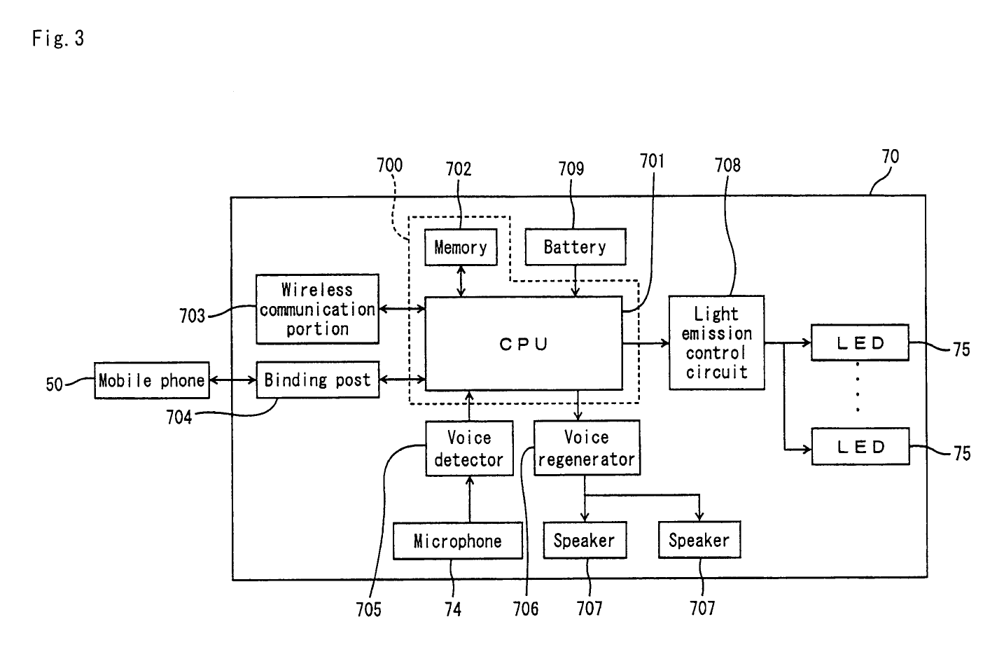

The two ear pads 72 are connected to each other by the headband 71, and each of the ear pads 72 has a speaker 707 (see FIG. 3) inside thereof so that a voice can be output. When a person wears the headset 70, each of the ear pads 72 is to cover each ear.

The microphone 74 is connected to either one of the ear pads 72 through the arm 73. The person wearing the headset 70 can input a voice from the microphone 74.

The LEDs 75 are red LEDs (visible LEDs), and three of those are provided on each of the ear pads 72. The LEDs 75 correspond to the light-emitting device in the present invention.

Out of the three LEDs 75, two LEDs, i.e. each LED (to be referred to as 75a) at both ends is controlled to alternately repeat the lighting and extinguishing every 1/30 seconds and is used in recognition of the current location thereof within a moving image captured by the camera 40. The lighting pattern of the LEDs 75a is common in all the headsets 70 to be worn by the registered people. The LEDs 75a correspond to the location-specifying light-emitting device in the present invention.

It is to be noted that the location-specifying light-emitting device may be always lighted up in the present invention.

One LED 75 (to be referred to as 75b) between the two LEDs 75a is used in identification of the headset 70 and the person wearing the headset 70, and is lighted up in a lighting pattern unique to each headset 70. The LED 75b corresponds to the signal-transmission light-emitting device in the present invention.

FIG. 3 is a block diagram showing an internal configuration of the headset.

The headset 70 comprises a control portion 700 controlling the headset 70. The control portion 700 comprises a CPU 701 and a memory storing a variety of data.

The CPU 70 is connected with a wireless communication portion 703, a binding post 704, a voice detector 705, a voice regenerator 706, a light emission control circuit 708 and a battery 709.

The wireless communication portion 703 is used when communicating with another headset 70 without involving the mobile phone 50.

The binding post 704 is connected with the mobile phone 50 so that transmitting and receiving data such as voice data is enabled between the headset 70 and the mobile phone 50. The voice detector 705 detects a voice input from the microphone 74 and converts it to a digital signal. The voice regenerator 706 converts voice data into an analog signal so as to output it from the speakers 707. Accordingly, in addition to being able to transmit the voice data indicating a voice input from the microphone 74 to the mobile phone 50 through the binding post 704, it is possible to output from the speakers 707 the voice data received from the mobile phone 50. Namely, using the mobile phone 50, communication with the telephone 20 and another mobile phone 50 can be conducted.

The light emission control circuit 708 controls the lighting of the LEDs 75, based on a command from the CPU 701. The light emission control circuit 708 corresponds to the control device in the present invention.

FIG. 4 is a block diagram showing an internal configuration of the computer shown in FIG. 1.

As shown in FIG. 4, the computer 10 is provided with a CPU 101; to the CPU 101, there are connected a ROM 102, a RAM 103, an HDD (hard disk drive) 104, a wireless communication portion 105, an image processing circuit 106, an input signal circuit 108, and a communication interface 111.

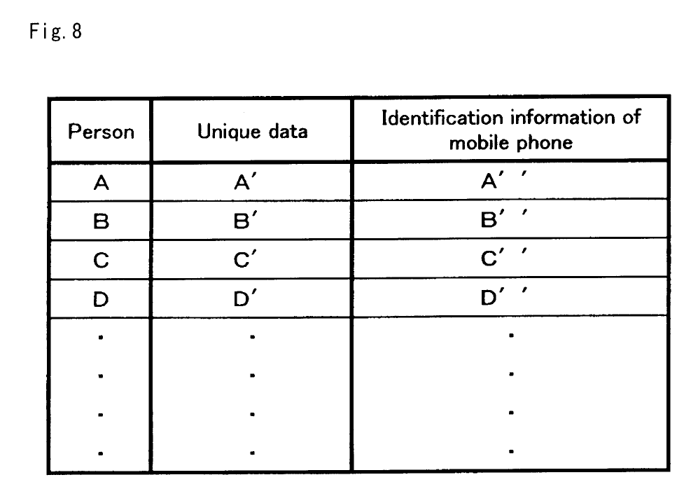

The ROM 102 stores: various types of programs for conducting processing necessary in control of the computer 10; a data table; and the like. The RAM 103 is a memory for temporarily storing various types of data calculated in the CPU 101, and the HDD 104 stores a unique data table to be referred to when identifying the lighting pattern of the LEDs 75. The details of the unique data table will be described later by using FIG. 8. The HDD 104 corresponds to the storage device in the present invention.

The wireless communication portion 105 is for transmitting and receiving data between the CPU 101 and the camera 40. The image processing circuit 106 is connected with the display 107 to which an image based on the image data received from the camera 40 through the wireless communication portion 105 is displayed. The display 107 corresponds to the display device in the present invention. Further, a keyboard 109 and a mouse 110 are connected to the input signal circuit 108. Operation of the keyboard 109 or the mouse 110 allows an input of various types of commands. The mouse 110 corresponds to the selection device in the present invention.

To the communication interface 111, the telephone 20 is connected. The computer 10 can transmit a command signal to the telephone 20 through the communication interface 111.

FIG. 5 is a block diagram showing an internal configuration of the telephone shown in FIG. 1.

The telephone 20 according to the present embodiment is capable of connecting to the computer 10 through a communication line; the telephone 20 is configured to start dialing, upon receipt of a signal commanding to dial and of phone number data of the call destination from the computer 10, through the communication line, based on the signal and the phone number data.

As shown in FIG. 5, the telephone 20 includes a CPU 201 to which the computer 10 is connected through a communication interface 207.

Further, the CPU 201 is connected with a ROM 204, a RAM 205, the transmitting/receiving portion 206 used for conversation, a display 202 for conducting various types of display, and an input unit 203 used when phone numbers and the like are manually input.

FIG. 6 is a block diagram showing an internal configuration of the camera shown in FIG. 1.

As shown in FIG. 6, to the CPU 401 included in the camera 40, there are connected a ROM 402, a RAM 403, an imager 404, and a wireless communication portion 405.

The imager 404 is provided with a lens, a CCD (Charge Coupled Device) and the like, and generates an image. Further, the imager 404 comprises a brightness data extracting portion that extracts data relating to the brightness of each color in the image data obtained by capturing images.

The wireless communication portion 405 is for transmitting and receiving data between the CPU 401 and the computer 10. The CPU 401 transmits image data indicating an image generated by the imager 404 to the computer 10, through the wireless communication portion 405.

It is to be noted that the number of transmission frames of the camera 40 is 30 frames per second.

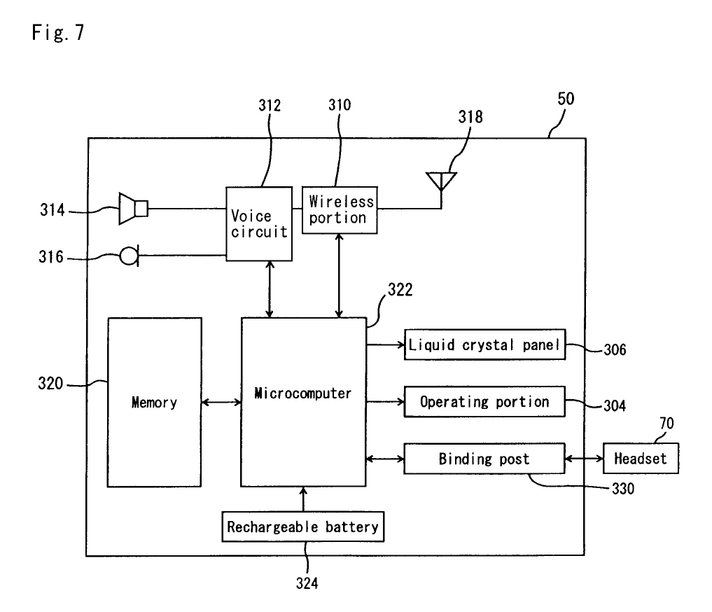

FIG. 7 is a block diagram showing an internal configuration of the mobile phone shown in FIG. 1.

The mobile phone 50 includes an operating portion 304, a liquid crystal panel 306, a wireless portion 310, a voice circuit 312, a speaker 314, a microphone 316, a transmitting/receiving antenna 318, a nonvolatile memory 320, a microcomputer 322, a rechargeable battery 324, and a binding post 330.

The wireless portion 310 is controlled by the microcomputer 322 so as to transmit and receive a signal on the airwaves to and from a base station, through the transmitting/receiving antenna 318. The voice circuit 312 outputs to the wireless portion 310 a voice signal output from the microphone 316, as a transmission signal, through the microcomputer 322, in addition to outputting to the speaker 314 a reception signal output from the wireless portion 310 through the microcomputer 322.

The speaker 314 converts the reception signal output from the voice circuit 312 into a reception voice to output it; the microphone 316 converts a transmission voice given from the operator into a voice signal so as to output it to the voice circuit 312.

The non-volatile memory 320 stores, for example, various types of data such as image data for wallpapers and music data for ringtones, and various types of programs, in a non-volatile manner.

The rechargeable battery 324 supplies power to each of the circuits. The microcomputer 322 is comprised of a CPU, a ROM, and a RAM, and conducts, for example, calling/receiving processing, e-mail creating and sending/receiving processing, Internet processing and the like.

The mobile phone 50 corresponds to the mobile terminal in the present invention.

The binding post 330 is connected with the headset 70 so that transmitting and receiving data such as voice data is enabled between the headset 70 and the mobile phone 50. When the mobile phone 50 is in communication, the microcomputer 322 transmits a communication-confirming signal indicating that the mobile phone 50 is in communication, to the headset 70 through the binding post 330 at predetermined intervals.

The mobile phone 50 corresponds to the mobile terminal in the present invention.

Next, the unique data table to be referred to in execution of recognition of the lighting pattern of the LEDs 75 provided on the headset 70 of a person whose images is captured by the individual-identifying communication system 1 is described. The unique data table is the data table stored in the HDD 104 of the computer 10.

FIG. 8 is a view showing an example of the unique data table.

In the unique data table, with the name of each of the plurality of registered people (facility employees), the unique data indicating the lighting pattern of the LEDs 75 provided on the headset 70 worn by the each person and the identification information data (phone number data) of the mobile phone 50 owned by the each person are associated.

For example, in the unique data table shown in FIG. 8, the unique data of the person named A is A′, and the identification information data of the mobile phone 50 of A is A′″.

The unique data is comprised of: data indicating the lighting pattern (the lighting pattern of alternately repeating the lighting and extinguishing every 1/30 seconds) of the LEDs 75a used in recognition of the current location; and data indicating the lighting pattern (e.g., the lighting pattern of alternately repeating the lighting for 1/10 seconds and the extinguishing for 1/5 seconds) of the LED 75b used in identification of the headset 70 and the person wearing the headset 70.

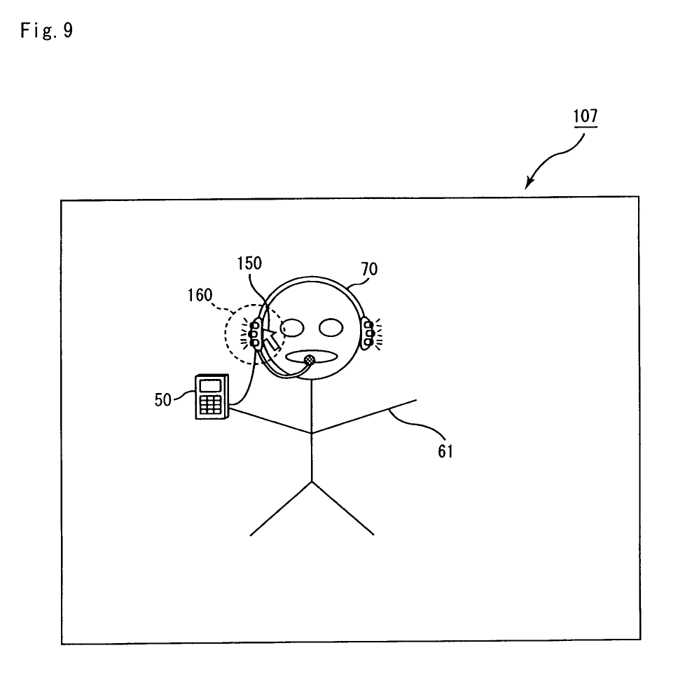

Next, a flow of recognition of lighting pattern of the LEDs 75 conducted in the individual-identifying communication system 1 will be described based on FIGS. 9 to 11.

FIGS. 9 to 11 are views showing an example of an image displayed to the display provided in the computer.

FIG. 9 is an example of an image displayed to the display 107 when an area including the lighting pattern of the headset 70 worn by the person in the image is selected.

As shown in FIG. 9, a portion corresponding to the neighborhood of the image showing the LEDs 75 in the image of the headset 70 is selected with a cursor 150 by using the mouse 110. A dashed circle 160 in the figure shows a circle with radius 80 pixels to be displayed taking the position of the cursor 150 as its center, when the mouse 110 is clicked; the portion surrounded by the dashed circle 160 shows the selected area (hereinafter, also referred to as a selection area). The image data showing the selection area corresponds to the selection area image data in the present invention.

It is to be noted that a configuration may be adopted in which, for example, the person selecting an area can specify a selection range as desired by drag-and-drop.

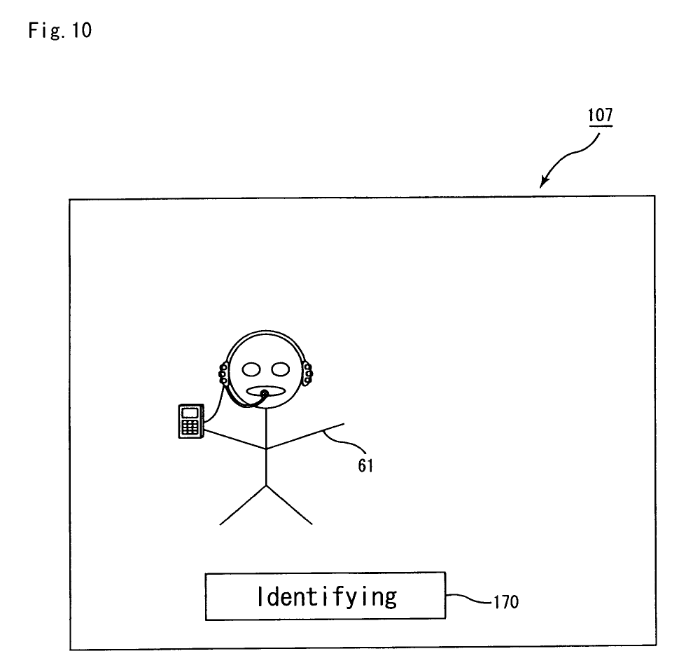

FIG. 10 is an example of an image displayed to the display 107 in recognition of the lighting pattern of the LEDs 75.

The computer 10 transmits to the camera 40 a signal commanding to zoom in when the area is selected with the mouse 110. The camera 40 captures an enlarged view of the place within the facility corresponding to the selected area. Then the computer 10 detects the image of the lighting LEDs 75 from the image obtained by zooming in. Specifically, the computer 10 determines the area in which pixels in a certain number or more in red, which is the lighting color of the LEDs 75, or in approximate colors are located continuously; when the brightness of the area is more than a threshold value, the computer 10 recognizes the image of the area as the image of the lighting LEDs 75.

Upon detection of the image of the lighting LEDs 75, the computer 10 acquires from selection area image data the lighting pattern data indicating the lighting pattern of the LEDs 75.

The computer 10 then refers to the unique data table stored in the HDD 104, and determines the unique data corresponding to the acquired acquisition lighting pattern data.

When the above-mentioned processing is executed, an identification-time image 170 showing “Identifying” which indicates execution of lighting pattern recognition is displayed to the display 107, as shown in FIG. 10.

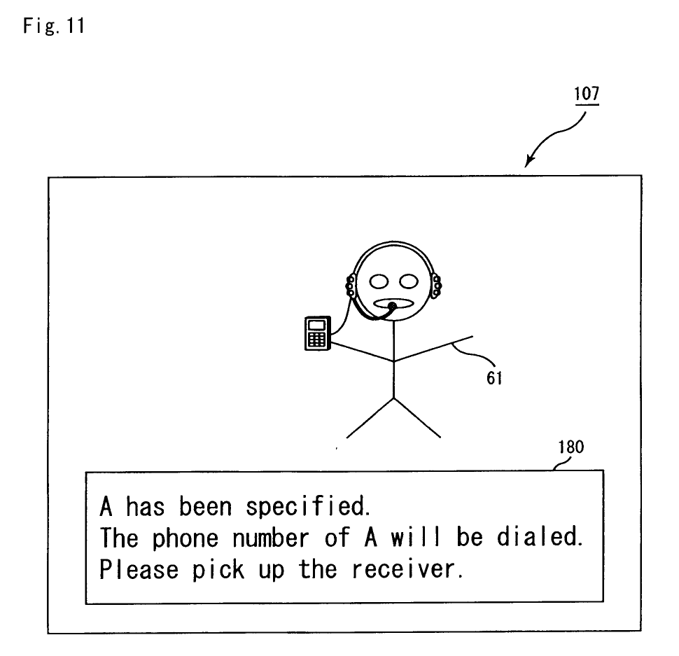

FIG. 11 is an example of an image displayed to the display 107 when the unique data corresponding to the acquisition lighting pattern data is determined.

Upon determination of the unique data, the computer 10 transmits to the telephone 20 a command signal indicating a command to dial the phone number of the mobile phone 50 assigned with the identification information data corresponding to the determined unique data, according to the corresponding relations in the unique data table. Namely, the computer 10 transmits to the telephone 20 a command signal indicating a command to dial the phone number of the mobile phone 50 used by the person corresponding to the determined unique data.

FIG. 11 shows an image displayed to the display 107 when it is determined that the unique data corresponding to the acquisition lighting pattern data is A′ (see FIG. 8). The person corresponding to the unique data A′ is A, as shown in FIG. 8, and an identification result image 180 indicating that the phone number of A will be dialed is displayed to the display 107, as shown in FIG. 11.

Since the identification information data of the mobile phone 50 corresponding to the unique data A′ is A′′, the computer 10 transmits to the telephone 20 a command signal commanding to dial the phone number of the mobile phone 50 used by the person A, based on the identification information data A′′.

The person viewing the display 107 is enabled to converse with the person A, through the transmitting/receiving portion 206 of the telephone 20.

Next, processing executed in the computer 10 is described.

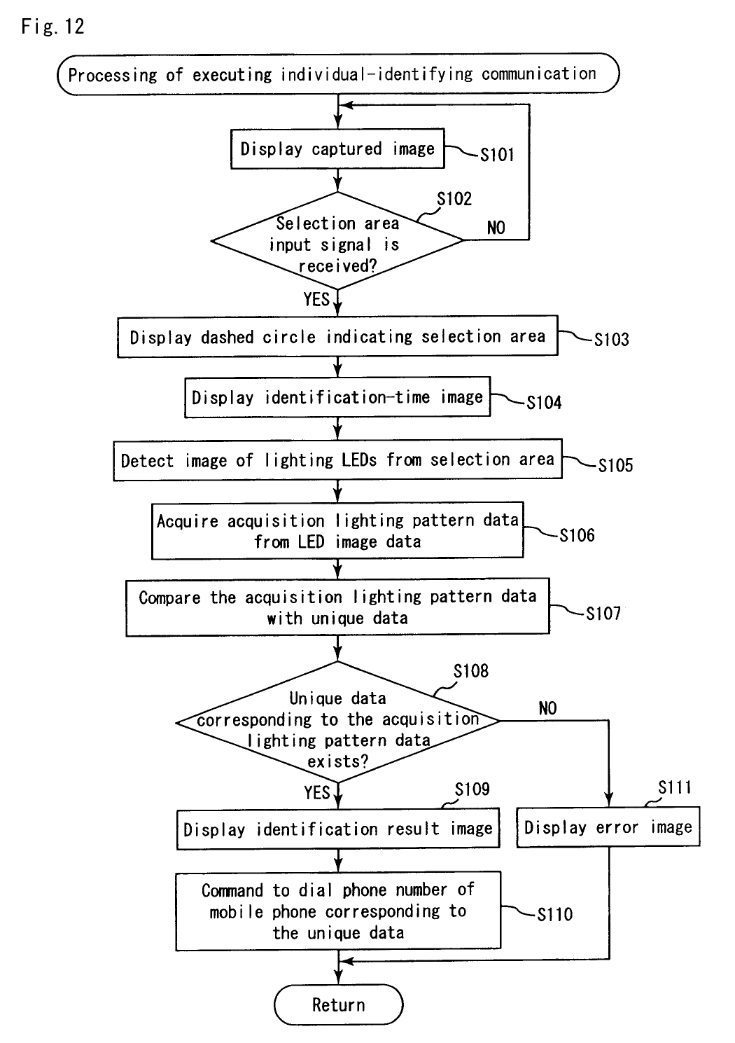

FIG. 12 is a flowchart showing a subroutine of processing of executing individual-identifying communication in the computer 10.

First, the CPU 101 provided in the computer 10 receives image data obtained by capturing images using the camera 40, through the wireless communication portion 105, and displays an image based on the received image data (step S101).

Next, the CPU 101 determines in step S102 whether or not a selection area input signal indicating that an area within the image is selected (clicked) with the mouse 110 is received from the input signal circuit 108.

When determining that the selection area input signal is not received, the CPU 101 returns the processing to step S101.

On the other hand, when determining that the selection area input signal is received, the CPU 101 displays the dashed circle 160 indicating the selection area to the display 107, in step S103 (see FIG. 9).

Next, in step S104, the CPU 101 displays the identification-time image 170 to the display 107 (see FIG. 10).

The CPU 101 then transmits to the camera 40 a signal commanding to zoom in. Upon receipt of the signal, the camera 40 captures an enlarged image of the place within the facility corresponding to the selection area (the portion surrounded by the dashed circle 160) after adjusting the capture angle within the above-described movable range.

The CPU 101 detects an image of the lighting LEDs 75 from the image obtained by zooming in (step S105).

In the processing of step S106, the CPU 101 detects the lighting of the LEDs 75a indicating the current location. As described above, since the LEDs 75a repeat the lighting and extinguishing every 1/30 seconds, the CPU 101 examines existence of the lighting of the image of at least 1/15 seconds, i.e. the image of at least 2 frames. Specifically, first, the CPU 101 determines the area in which pixels in a certain number or more in red, which is the lighting color of the LEDs 75, or in approximate colors are located continuously. Then, the CPU 101 obtains the brightness of the area based on the brightness data obtained by the camera 40. When the brightness of the area is more than the threshold value, the CPU 101 recognizes the image of the area as the image of the lighting LEDs 75.

Next, the CPU 101 analyzes the image of a certain period of time of selection area including the image of the LEDs 75 detected in step S105, in the way similar to the processing of step S105, so as to acquire the acquisition lighting pattern data including the lighting pattern of the LEDs 75b used in identification of the headset 70 and the person wearing the headset 70 (step S106).

When executing the processing of step S106, the CPU 101 functions as the acquisition device in the present invention.

In step S107, the CPU 101 compares the acquisition lighting pattern data acquired in step S106 with the unique data included in the unique data table stored in the HDD 104. Specifically, the CPU 101 determines whether or not the lighting pattern indicated by the acquisition lighting pattern data matches the lighting pattern indicated by the unique data. When executing the processing of step S107, the CPU 101 functions as the determination device in the present invention.

Next, in step S108, the CPU 101 determines whether or not the unique data corresponding to the acquisition lighting pattern data exists. Namely, the CPU 101 determines whether or not the unique data matching the acquisition lighting pattern data exists.

When determining that the unique data corresponding to the acquisition lighting pattern data does not exist, the CPU 101 displays an error image saying “the specified person has not been registered” to the display 107 (step S111).

On the other hand, when determining that the unique data corresponding to the acquisition lighting pattern data exists, the CPU 101 displays the identification result image 180 to the display 107, in step S109 (see FIG. 11).

In step S110, the CPU 101 transmits, to the telephone 20, the identification information data (phone number data) corresponding to the unique data determined to match within the predetermined error range the acquisition lighting pattern data, and a command signal indicating a command to dial the phone number of the mobile phone 50 (the mobile phone 50 owned by the person corresponding to the unique data) assigned with the identification information data.

Upon receipt of the phone number data and the command signal, the telephone 20 identifies the phone number based on the phone number data. Then, after detecting that a receiver (the transmitting/receiving portion 206) has been picked up or that an input selecting a handsfree function has been entered from the input unit 203, the telephone 20 dials the identified phone number.

After executing the processing of step S110 or step S111, the CPU 101 terminates the present subroutine.

In the present embodiment, when the headset 70 is in communication through the mobile phone 50, the LED 75 provided on the headset 70 light up in a lighting pattern different from the lighting pattern indicated by the unique data corresponding to the headset 70.

Hereinafter, lighting pattern change processing conducted in the control portion 700 in the headset 70 will be described.

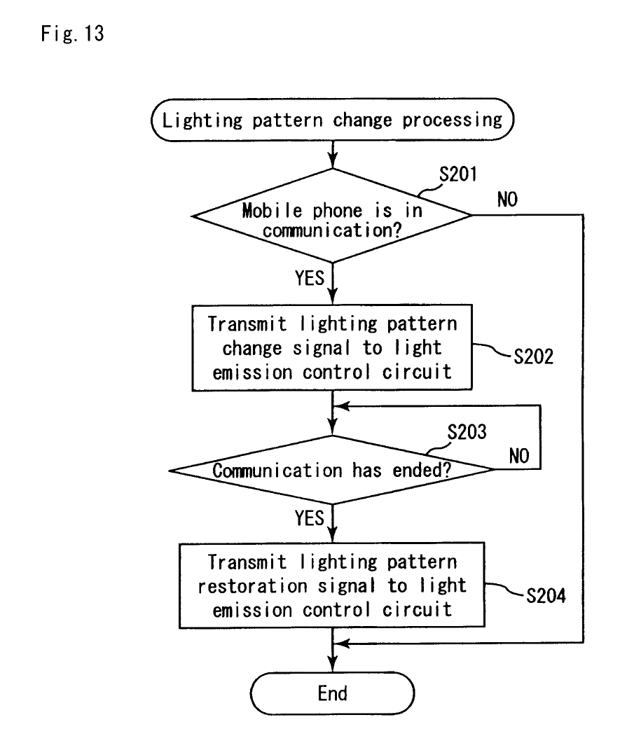

FIG. 13 is a flowchart showing a subroutine of lighting pattern change processing conducted in the control portion of the headset. The lighting pattern change processing is executed at predetermined time intervals in the control portion 700 of the headset 70.

First, in step S201, the CPU 701 provided in the control portion 700 of the headset 70 judges whether or not the mobile phone 50 is in communication. Namely, the CPU 701 judges whether or not a communication-confirming signal indicating that the mobile phone 50 is in communication has been received from the microcomputer 322 provided in the mobile phone 50. When executing the processing of step S201, the CPU 701 functions as the judging device in the present invention.

When judging that the mobile phone 50 is not in communication, the CPU 701 terminates the present subroutine.

On the other hand, when judging that the mobile phone 50 is in communication, the CPU 701 transmits to a light emission control circuit 708 (see FIG. 3) a lighting pattern change signal indicating a command to change the lighting pattern of the LED 75. Upon receipt of the lighting pattern change signal, the light emission control circuit 708 changes the lighting pattern of the LED 75b to a communication lighting pattern indicating the state of communicating. The communication lighting pattern is a lighting pattern different from the lighting pattern of the LEDs 75b indicated by the unique data, and is different in each headset 70.

Next, in step 203, the CPU 701 judges whether or not communication of the mobile phone 50 has been ended. Namely, the CPU 701 judges whether or not the communication-confirming signal from the mobile phone 50 is not received any more.

When judging that communication of the mobile phone 50 has not ended, the CPU 701 returns the processing to step S203.

On the other hand, when judging that communication of the mobile phone 50 has ended, the CPU 701 restores, in step S204, the lighting pattern of the LED 75, i.e., transmits a lighting pattern restoration signal indicating a command to restore the lighting pattern indicated by the unique data to the light emission control circuit 708. Upon receipt of the lighting pattern restoration signal, the light emission control circuit 708 changes the lighting pattern of the LED 75b to the LED 75b lighting pattern indicated by the unique data.

After executing the processing of step S204, the CPU 701 terminates the present subroutine.

As described above, the individual-identifying communication system 1 according to the present embodiment comprises: the plurality of LEDs 75 (light-emitting device) which light up in lighting patterns different from one another; the camera 40 (imaging device); the display 107 (display device) capable of displaying an image based on an image data obtained by capturing images using the camera 40; the mouse 110 (selection device) for selecting a predetermined area within the image displayed to the display 107; the HDD 104 (storage device) storing a plurality of identification information data different from one another for specifying the mobile phone 50 (mobile terminal) to communicate with, each of the identification information data being associated with a unique data indicating a lighting pattern of each of the LEDs 75; the CPU 101 (acquisition device) acquiring an acquisition lighting pattern data indicating the lighting pattern of the LEDs 75, from an image data obtained by capturing images using the camera 40, and determining, based on the acquisition lighting pattern data that has been acquired from a selection area image data indicating an image of the area selected by using the mouse 110 and on the plurality of unique data previously stored in the HDD 104, the unique data corresponding to the acquisition lighting pattern data; and the telephone 20 communicating with the mobile phone 50 assigned with the identification information data associated with the unique data determined.

According to the individual-identifying communication system 1, an image based on image data obtained by the camera 40 is displayed to the display 107; and when a predetermined area within the displayed image is selected by the mouse 110, the acquisition lighting pattern data indicating lighting pattern of the LEDs 75 is acquired from selection area image data indicating the image of the area. Then, based on the acquired acquisition lighting pattern data and the plurality of unique data stored in the HDD 104, the unique data corresponding to the acquired acquisition lighting pattern data is determined.

Namely, the unique data corresponding to the acquired acquisition lighting pattern data is determined by recognizing the lighting pattern of the captured LEDs 75. In the case that a person to have a LED 75 is predetermined for each LED 75, identification of the LEDs 75 (determination of the unique data) enables identification of the person having the LEDs 75. Further, since the lighting pattern of the LEDs 75 can be stably detected unless the light emitted from the light-emitting device is blocked by people or the like, it is possible to drastically diminish the restriction on identification of a person, such that for example the person having the LEDs 75 must face front with respect to the imaging device. Accordingly, the person in the image can be easily identified.

When the unique data corresponding to the acquired acquisition lighting pattern data is determined, communication is started with the mobile phone 50 with which identification information data associated with the determined unique data is assigned.

Namely, since it is possible to communicate with the mobile phone 50 corresponding to the LEDs 75 in the image, only selecting the area including the LEDs 75 owned by the person to contact to in the image enables communication with the mobile phone 50 used by the person. Therefore, it is not required to memorize the names of the people having the LEDs 75 and the phone numbers of the mobile phone 50 or search those in each case, thereby saving the facility administrator the trouble. Further, it becomes possible to take prompt actions even when an emergency contact is required.

In the present embodiment, a case has been described where the red LEDs (visible light LEDs) are used as the light-emitting device. However, the light-emitting device in the present invention is not limited to the visible light LEDs; for example, infrared LEDs may be used. In that case, an infrared camera should be used as the imaging device. Further, for example, a lamp such as a halogen bulb may be used.

Furthermore, in the present embodiment, a case has been described in which the telephone 20 is connected to the computer 10 through a communication line, and a call is made by transmission of a command signal from the computer 10 to the telephone 20. Namely, a case has been described in which the communication device in the present invention is the telephone 20, and the communication device is connected to the computer through a communication line. However, the communication device in the present invention is not limited to this example. For example, a computer with a telephone function (a so-called computer phone), which has a handset and a headset, maybe used. In this case, a configuration can be adopted in which lighting pattern recognition processing and processing of making a phone call to a specified person are executed in a single computer.

Further, in the present embodiment, a case has been described in which an area within an image displayed to the display 107 is selected by the mouse 110. Namely, a case has been described in which the selection device in the present invention is a mouse (a pointing device). However, the selection device in the present invention is not limited to a pointing device. For example, the selection device may be a touch panel installed on the front surface of a display (display device). When a touch panel is used as the selection device, it is possible to easily specify a selecting area intuitively by touching a predetermined place on the touch panel corresponding to the selection-desired area within the image.

Furthermore, in the present embodiment, a case has been described in which the mobile phone 50 is used as the mobile terminal. However, the mobile terminal in the present invention is not limited to a mobile phone; for example, it may be a wireless communication instrument. In the case of using a wireless communication instrument as the mobile terminal, data indicating a frequency unique to the wireless communication instrument and the unique data of the person using the wireless communication instrument should be stored in association with one another.

It is to be noted that the technology of detecting the lighting of a light emitter based on brightness data from an image obtained by capturing images has been disclosed in JP-B 3671460 and so on.

Although the present invention has been described with reference to embodiments thereof, these embodiments merely illustrate specific examples, not restrict the present invention. The specific structures of respective means and the like can be designed and changed as required. Furthermore, there have been merely described the most preferable effects of the present invention, in the embodiments of the present invention. The effects of the present invention are not limited to those described in the embodiments of the present invention.

What is claimed as new and desired to be secured by Letters Patent of the united states is:

1. An individual-identifying communication system comprising:
a plurality of light-emitting devices which light up in lighting patterns different from one another;
an imaging device;
a display device capable of displaying an image based on an image data obtained by capturing images using said imaging device;
a selection device for selecting a predetermined area within the image displayed to said display device;
a storage device storing a plurality of identification information data different from one another for specifying a mobile terminal to communicate with, each of the identification information data being associated with a unique data indicating a lighting pattern of each of said light-emitting device;
an acquisition device acquiring an acquisition lighting pattern data indicating the lighting pattern of said light-emitting device, from the image data obtained by capturing images using said imaging device;
a determination device determining, based on the acquisition lighting pattern data that has been acquired by said acquisition device from a selection area image data indicating an image of the area selected by using said selection device and on the plurality of unique data previously stored in said storage device, the unique data corresponding to the acquisition lighting pattern data; and
a communication device communicating with a mobile terminal assigned with the identification information data associated with the unique data determined by said determination device.

2. The individual-identifying communication system according to claim 1,
wherein
each of said light-emitting device comprises a location-specifying light-emitting device that lights up in a lighting pattern common in all of said light-emitting devices, and a signal-transmission light-emitting device that lights up in a lighting pattern different for each of said light-emitting device.

3. The individual-identifying communication system according to claim 1,
further comprising:
a control device controlling lighting of each of said light-emitting device; and
a judging device judging whether or not said mobile terminal is in communication,
wherein
said control device lights up a light-emitting device corresponding to the unique data associated with the identification information data of the mobile terminal, in a lighting pattern indicated by said unique data of the light-emitting device, when said judging device has judged that said mobile terminal is not in communication, and
said control device lights up the light-emitting device corresponding to the unique data associated with the identification information data of the mobile terminal, in a lighting pattern different from the lighting pattern indicated by said unique data of the light-emitting device, when said judging device has judged that said mobile terminal is in communication.

4. The individual-identifying communication system according to claim 1,
wherein
said light-emitting device is an LED, and
said LED is provided on a headset.

5. The individual-identifying communication system according to claim 1,
wherein
said selection device is a pointing device.

6. The individual-identifying communication system according to claim 1,
wherein
said selection device is a touch panel installed on the front surface of said display device.

7. The individual-identifying communication system according to claim 1,
wherein
said mobile terminal is a mobile phone, and said identification information data is a phone number data indicating the phone number of said mobile phone.

8. An individual-identifying communication system comprising:
a plurality of light-emitting devices which light up in lighting patterns different from one another;
a camera;
a display device capable of displaying an image based on an image data obtained by capturing images using said camera;
an input device for selecting a predetermined area within the image displayed to said display device;
a memory storing a plurality of identification information data different from one another for specifying a mobile terminal to communicate with, each of the identification information data being associated with a unique data indicating a lighting pattern of each of said light-emitting devices;
a communication device capable of communicating with said mobile terminal; and
a controller,
said controller programmed to execute the processing of
(a) capturing images using said camera,
(b) displaying to said display device an image based on an image data obtained in said processing (a),
(c) selecting a predetermined area within the image displayed to said display device, based on an input from said input device,
(d) acquiring an acquisition lighting pattern data indicating the lighting pattern of said light-emitting device, from the image data obtained by capturing images using said camera,
(e) determining, based on an acquisition lighting pattern data acquired from a selection area image data indicating an image of the area selected in said processing (c) and the plurality of unique data previously stored in said memory, the unique data corresponding to the acquired acquisition lighting pattern data, and
(f) communicating, through said communication device, with a mobile terminal assigned with the identification information data associated with the unique data determined in said processing (e).

9. A program executed in an individual-identifying communication system that comprises: a plurality of light-emitting devices which light up in lighting patterns different from one another; a camera; a display device capable of displaying an image based on an image data obtained by capturing images using said camera; an input device for selecting a predetermined area within the image displayed to said display device; a memory storing a plurality of identification information data different from one another for specifying a mobile terminal to communicate with, each of the identification information data being associated with a unique data indicating a lighting pattern of each of said light-emitting devices; and a communication device capable of communicating with said mobile terminal, said program comprising
an image capture step of capturing images using said camera,
a display step of displaying to said display device an image based on an image data obtained using said camera,
a selection step of selecting a predetermined area within the image displayed to said display device, based on an input from said input device,
an acquisition step of acquiring an acquisition lighting pattern data indicating the lighting pattern of said light-emitting device, from the image data obtained by capturing images using said camera,
a determination step of determining, based on the acquisition lighting pattern data acquired from a selection area image data indicating an image of the area selected by said input device and on the plurality of unique data previously stored in said memory, the unique data corresponding to the acquisition lighting pattern data, and
a communication step of communicating, through said communication device, with a mobile terminal assigned with the identification information data associated with the unique data determined in said determination step.
